(19) United States
(12) Patent Application Publication
(10) Pub. No.: US 2024/0123370 A1
(43) Pub. Date: Apr. 18, 2024

(54) ION FILTER

(71) Applicants: Hyundai Motor Company, Seoul (KR); Kia Corporation, Seoul (KR)

(72) Inventors: Kyeong Jun BAEK, Seongnam-si (KR); Sun Ae Park, Seongnam-si (KR); Hun Woo Park, Namyangju-si (KR); Hyung Geun Cho, Haeundae-gu (KR); Young Sang Cho, Yongin-si (KR); Sang Pil Byun, Hwaseong-si (KR)

(21) Appl. No.: 18/177,365

(22) Filed: Mar. 2, 2023

(30) Foreign Application Priority Data
Oct. 13, 2022 (KR) 1020220131335

(51) Int. Cl. B01D 15/14; B01D 15/22; B01D 15/36; F16K 27/02; F16K 31/524

(52) U.S. Cl. CPC B01D 15/14; B01D 15/22; B01D 15/361; F16K 27/02; F16K 31/52408; H01M 8/04044

(57) ABSTRACT

An ion filter for circulating coolant in a fuel cell stack of a fuel cell vehicle includes a housing including an inlet configured so that a fluid is introduced and an outlet configured so that the fluid is discharged, a filter element accommodated in the housing to filter the fluid, a valve assembly provided on the inlet and configured to operate the flow of the fluid introduced into the housing through the inlet to be allowed or blocked, and a gate member provided in the housing and configured to adjust an operation of the valve assembly.

### CROSS-REFERENCE TO RELATED APPLICATION

This application claims under 35 U.S.C. § 119(a) the benefit of priority to Korean Patent Application No. 10-2022-0131335 filed on Oct. 13, 2022, the entire contents of which are incorporated herein by reference.

### TECHNICAL FIELD

The present disclosure relates to an ion filter and, particularly, to an ion filter used for circulating a coolant in a fuel cell stack of a fuel cell vehicle.

### BACKGROUND

A fuel cell system generates electric energy through an electrochemical reaction of reaction gases in a fuel cell stack. The fuel cell stack is connected to an air supply device configured to supply air containing oxygen required for the electrochemical reaction and a hydrogen supply device configured to supply hydrogen as fuel. The fuel cell system also includes a heat and water management system for discharging heat and water generated as a result of the electrochemical reaction in the fuel cell stack to the outside.

As described above, the fuel cell stack discharges heat and water as by-products of the reaction between hydrogen and oxygen, which are reaction gases. Therefore, the fuel cell system includes a cooling device for cooling the stack to prevent an increase in a temperature of the stack and uses a water cooling type for cooling the stack by circulating a coolant through a coolant channel in the stack.

A fuel cell ion filter is provided in a circulation line of the coolant which circulates through the stack and exits the stack. The ion filter improves the electrical insulation stability of the vehicle by maintaining an electrical conductivity increased by positive and negative ions present in the coolant to a certain level or less.

An ion filter cartridge filled with an ion exchange resin is mounted in an ion filter housing, and the cartridge needs to be replaced at a certain period due to a filtering life of the ion exchange resin. Due to a need for the periodic management, an upper portion of the ion filter housing needs to be positioned at an uppermost end of a thermal management system (TMS) to minimize the leakage of the coolant when the cartridge is replaced.

As shown in FIG. 1, an upper portion of an ion filter housing 610 is disposed to match an uppermost line of the TMS approximately indicated by A1. To this end, a length of a mounting bracket 630 is greatly increased so that an upper end of the ion filter housing 610 is disposed at the same position as the line A1.

When the upper portion of the ion filter housing 610 is disposed on a line A2, that is, when it is disposed at a lower position than the line A1, the upper portion of the ion filter housing 610 is lower than an uppermost end of a coolant line. In this case, there is a problem of excessive loss of coolant after the ion filter cartridge is replaced.

When the upper portion of the ion filter housing 610 is disposed to approximately match a line A3, the upper portion of the ion filter housing 610 is higher than the uppermost end of the coolant line. In this case, air bubbles are collected in the ion filter, and the flow of coolant may be lowered.

As described above, there is a restriction in the arrangement of the ion filter to be disposed to correspond to the uppermost end of the TMS, and the overall weight and cost of the vehicle are increased due to the increase in the length of the mounting bracket 630.

### SUMMARY

The present disclosure has been made in efforts to solve the problem, and is directed to providing an ion filter which overcomes head restrictions in a fuel cell system and is easily maintained.

In addition, the present disclosure is directed to providing an ion filter whose shape may be freely configured.

An ion filter according to the present disclosure includes a housing including an inlet configured so that a fluid is introduced and an outlet configured so that the fluid is discharged, a filter element accommodated in the housing to filter the fluid, a valve assembly provided on the inlet and configured to operate the flow of the fluid introduced into the housing through the inlet to be allowed or blocked, and a gate member provided in the housing and configured to adjust an operation of the valve assembly.

According to the present disclosure, it is possible to provide the ion filter which overcomes a head restriction in the fuel cell system and is easily maintained.

In addition, according to the present disclosure, it is possible to provide the ion filter in which the shape of the ion filter housing can be freely configured.

The effects of the present disclosure are not limited to the above-described effects, and other effects not mentioned will be able to be clearly recognized by those skilled in the art from the following description.

### BRIEF DESCRIPTION OF THE DRAWINGS

FIG. 1 is a diagram illustrating a conventional ion filter in a fuel cell system for a vehicle.

FIG. 2A is a diagram illustrating an example of an ion filter.

FIG. 2B is a diagram illustrating an example of an ion filter from which a part of a housing in FIG. 2A is removed.

FIG. 3 is a diagram illustrating a front view of an example of the ion filter from which the part of the housing has been removed.

FIG. 4 is a diagram illustrating an enlarged view of an example of a portion indicated by P1 in FIG. 3.

FIG. 5 is a diagram illustrating a top side view of an example of a lid of the ion filter.

FIGS. 6A to 6C are diagrams illustrating an example of a part of the ion filter and describing an example of an associated operation between the lid and a gate member;

FIG. 7 is a diagram illustrating another example of the coupling relationship between the gate member and a filter element of the ion filter.

FIG. 8 is a diagram illustrating an enlarged view of an example of a portion indicated by P2 in FIG. 3;

FIG. 9 is a diagram illustrating an example of an exploded perspective view of an example of a valve assembly of FIG. 8;

FIGS. 10A, 10B and 10C are diagrams illustrating an example of a linking operation of the gate member and the valve assembly for allowing or blocking the flow of coolant into the ion filter.

FIG. 11 is a diagram illustrating an example of a ventilation state of the ion filter.

FIG. 12 is a diagram illustrating an example of a state display part and a selector for allowing a state in which the flow of coolant into the ion filter is allowed or blocked to be observed from the outside as a portion of the lid of the ion.

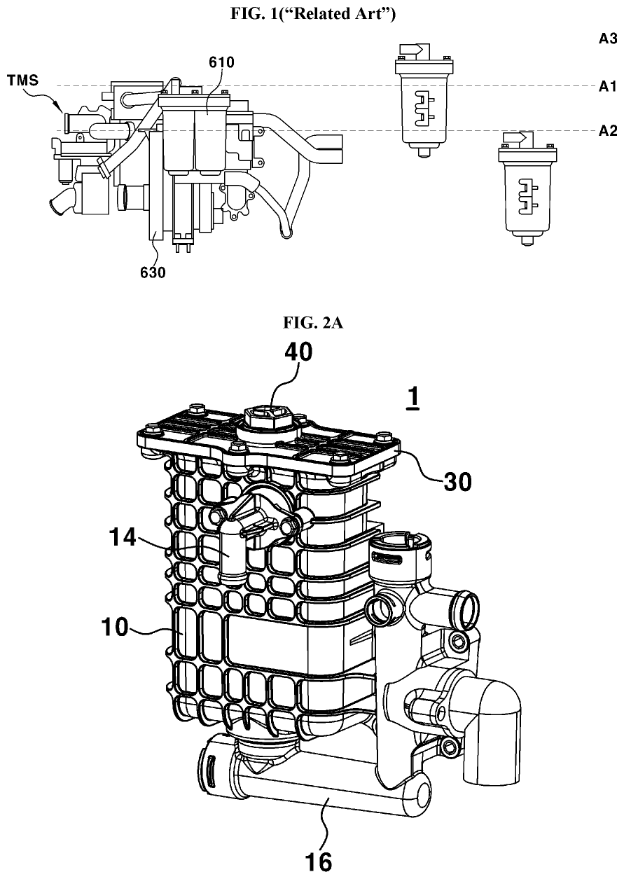

### DETAILED DESCRIPTION

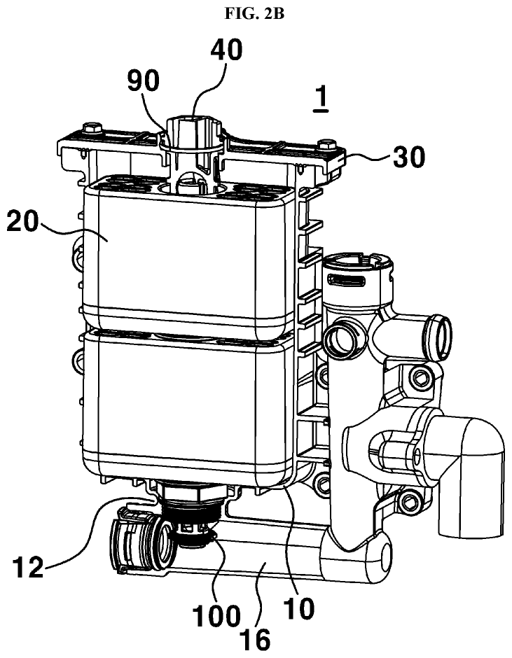

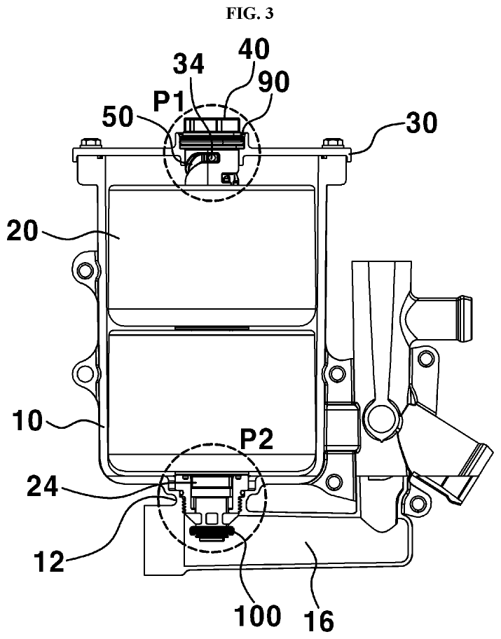

Referring to FIGS. 2A, 2B, and 3, an ion filter 1 includes a housing 10. A filter element 20 is accommodated in the housing 10. The filter element 20 is configured to filter ions present in a coolant passing through the ion filter 1. In some implementations, the filter element 20 is a cartridge filter. According to the present disclosure, the housing 10 and the filter element 20 may have a cylindrical shape or may have a shape of a polygonal pillar, such as a rectangular pillar. In particular, the filter element 20 may be operated by a gate member 40 to be described below even when the filter element 20 does not have a circular cross section.

In addition, a lid 30 is detachably coupled to the housing 10. In some implementations, a coupling hole 36 is provided in the lid 30. An insertion hole aligned with the coupling hole 36 is also provided in the housing 10. The coupling hole 36 and the insertion hole are mounted so that a fastening member, such as a bolt, passes through, and thus the housing 10 and the lid 30 may be separably coupled. In addition, the lid 30 is watertightly coupled to the housing 10 so that the coolant in the housing 10 does not leak between the lid 30 and the housing 10.

The housing 10 includes an inlet 12 through which the coolant from the outside is introduced and an outlet 14 through which the coolant having passed through the housing 10 is discharged to the outside. In some implementations, the inlet 12 may be connected to a tubular portion 16. The tubular portion 16 is connected to a manifold, an external hose, or a pipe portion for supplying a coolant to the ion filter 1. In addition, in some implementations, the outlet 14 may be provided on the lid 30 or in the housing 10.

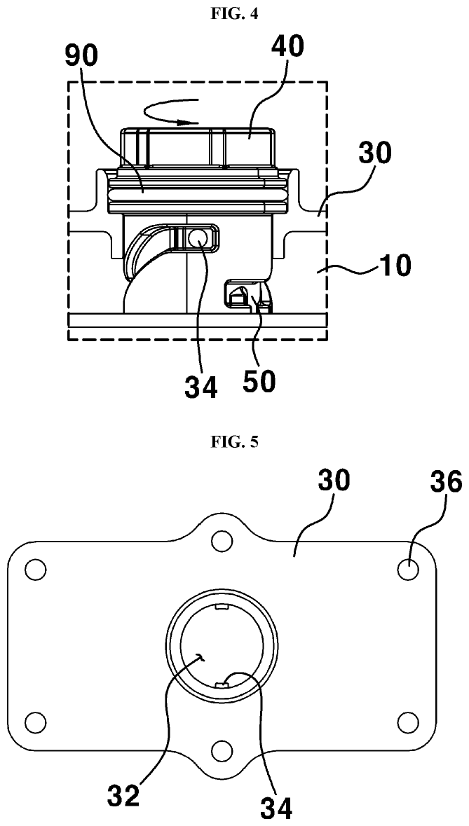

As shown in FIG. 4, the gate member 40 is mounted on the lid 30. Specifically, the gate member 40 is rotatably mounted with respect to the lid 30. The gate member 40 allows the filter element 20 to be easily replaced while minimizing the loss of coolant when the filter element 20 is replaced.

To this end, the gate member 40 is operatively coupled to the lid 30. A guide groove 50 is formed in the gate member 40. The guide groove 50 is formed to be recessed in an outer surface of the gate member 40 and extends in a substantially longitudinal direction of the gate member 40.

In addition, as well shown in FIG. 5, the lid 30 includes an opening 32. The gate member 40 is rotatably mounted in the opening 32. The opening 32 of the lid 30 is provided with a protrusion 34. In some implementations, a pair of protrusions 34 may be provided to face each other. The protrusion 34 is seated in the guide groove 50 of the gate member 40, and the gate member 40 may rotate in a state in which the protrusion 34 is seated in the guide groove 50. Therefore, the protrusion 34 is fixed to the lid 30, but when the protrusion 34 is viewed from the guide groove 50, it may be perceived that the protrusion 34 relatively moves along the guide groove 50 when the gate member 40 rotates.

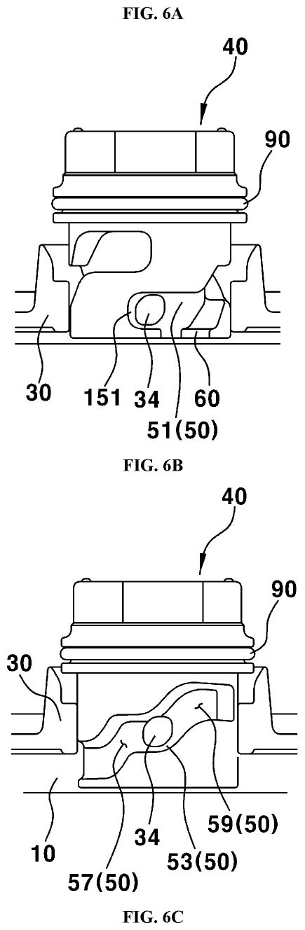

As shown in FIGS. 6A to 6C, the guide groove 50 is configured to extend from a lower side to an upper side of the gate member 40 along a circumference of the gate member 40. The guide groove 50 includes a lower flat portion 51, an intermediate flat portion 53, and an upper flat portion 55. A lower inclined portion 57 extending obliquely along the circumference of the gate member 40 is provided in the guide groove 50 between the lower flat portion 51 and the intermediate flat portion 53. Also, the guide groove 50 includes an upper inclined portion 59 obliquely extending along the circumference of the gate member 40 between the intermediate flat portion 53 and the upper flat portion 55.

In some implementations, the upper flat portion 55 is provided with an upper stopper 155. In addition, the lower flat portion 51 is provided with a lower stopper 151. The lower stopper 151 and the upper stopper 155 are configured to restrict the vertical movement of the filter element 20 by limiting the movement of the protrusion 34. As described above, the protrusion 34 may include a plurality of positions while continuously moving from the lower flat portion 51 to the upper flat portion 55 of the guide groove 50.

The guide groove 50 may include a separation groove 60. The separation groove 60 may be configured to extend vertically from the guide groove 50, for example, the lower flat portion 51 to the lower side of the gate member 40. The separation groove 60 enables the lid 30 coupled to the gate member 40 to be separated from the gate member 40. However, even when the separation groove 60 is not present, the protrusion 34 of the lid 30 and the guide groove 50 of the gate member 40 may be attached or detached together in a coupled state.

A packing member 90 is mounted between the gate member 40 and the lid 30. When a valve assembly 100 is in an open state (i.e., allowing the flow of coolant through the ion filter 1), the packing member 90 may seal an inner side and outer side of the housing 10. Therefore, the coolant passing through the ion filter 1 is only discharged through the outlet 14. However, as described below, the ion filter 1 may be set to a ventilation state. In this case, the packing member 90 is spaced apart from the opening 32, and the valve assembly 100 may be in a partially open state.

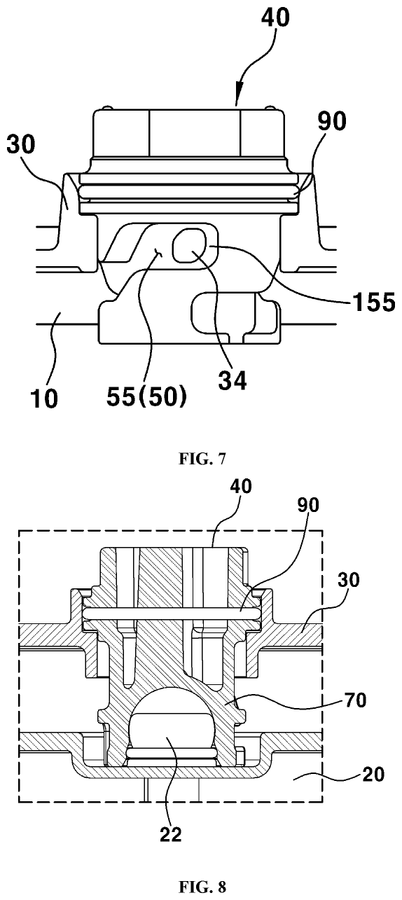

As shown in FIG. 7, the gate member 40 is rotatably fixed to the filter element 20. To this end, the gate member 40 includes a connection part 70. In some implementations, the connection part 70 may be a socket joint provided at a lower end of the gate member 40. The filter element 20 includes a coupling part 22. The coupling part 22 is connected to the connection part 70 to rotatably fix the gate member 40. In some implementations, the coupling part 22 may be a ball joint inserted into and mounted to the connection part 70. Therefore, the filter element 20 may move vertically within the housing 10 by the rotation of the gate member 40. Of course, an extra space is present in the housing 10 in which the filter element 20 may move vertically.

As shown in FIG. 8, the ion filter 1 according to the present disclosure includes the valve assembly 100. The valve assembly 100 is mounted to the inlet 12 of the ion filter 1 and operatively associated with the gate member 40. This will be described below. The valve assembly 100 includes a closed position at which the flow to the inlet 12 of the ion filter 1 is blocked, an open position at which the flow through the inlet 12 of the ion filter 1 is allowed, and a partially open position between the closed position and the open position.

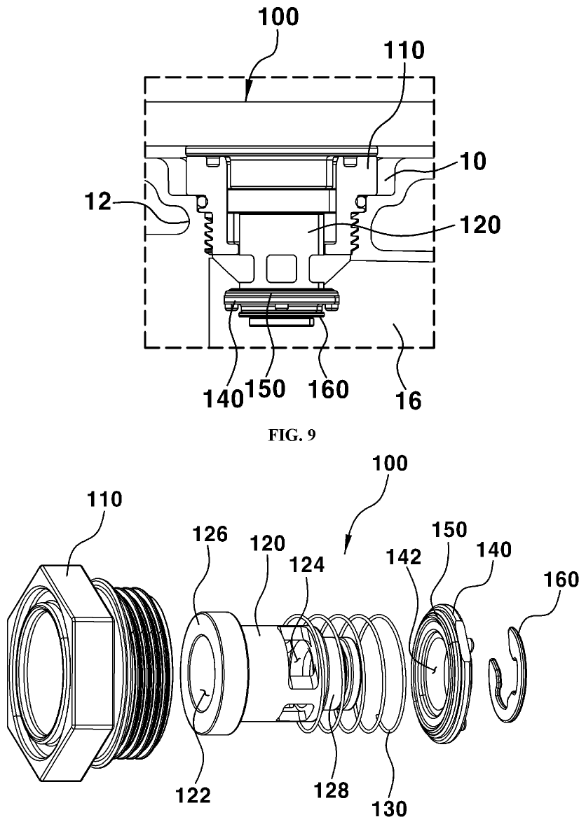

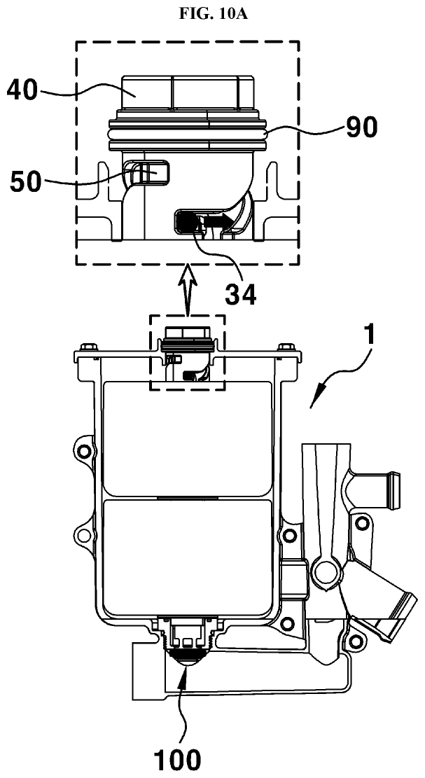

As well shown in FIG. 9, the valve assembly 100 includes a valve housing 110. The valve housing 110 is fixed to the housing 10. In some implementations, the valve housing 110 is thread-coupled into the housing 10. In some implementations, the valve housing 110 may be seated on and fixed to the inlet 12 of the housing 10.

The valve assembly 100 includes a core 120. The core 120 is accommodated inside the valve housing 110. The core 120 is accommodated inside the valve housing 110 such that the core 120 may linearly move in a longitudinal direction of the housing 10.

The core 120 includes a hollow 122. The hollow 122 is formed in a longitudinal direction of the core 120, and the coolant flows through the hollow 122. The core 120 is formed with an opening 124 passing through a circumference thereof. The coolant may flow into an inner side or the hollow 122 of the core 120 through the opening 124.

An elastic member 130 is mounted between the valve housing 110 and the core 120. The elastic member 130 is supported by the valve housing 110. When the core 120 moves toward the elastic member 130, the elastic member 130 is compressed between a flange 126 formed at one end of the core 120 and the valve housing 110. When the core 120 returns to an original position, the elastic member 130 returns to the original position between the flange 126 and the valve housing 110. As a non-limiting example, the elastic member 130 may be a spring. However, the elastic member 130 may be a member made of various materials and having various structures capable of providing a restoring force as well as the spring.

A plate member 140 is coupled to the core 120. In some implementations, the core 120 may be provided with an engagement part 128 which may be inserted into the plate member 140. The plate member 140 may be formed with a hole 142 into which the engagement part 128 may be inserted. The plate member 140 may block the inlet 12 or a flow path formed in the housing 10. The plate member 140 is coupled to the core 120 to be positioned outside the valve housing 110. A sealing member 150 for watertightness may be provided on a surface of the plate member 140 coming into contact with the valve housing 110. The plate member 140 can prevent backflow by coming into close contact with the valve housing 110 when the flow of coolant is blocked.

A retainer ring 160 is mounted on the coupling part 22 of the core 120 having passed through the hole 142. The retainer ring 160 fixes the core 120 and the plate member 140. As a non-limiting example, the retainer ring 160 may be an E-ring.

Referring back to FIG. 3, the filter element 20 includes a contact part 24. The contact part 24 operatively associates the valve assembly 100 with the gate member 40. Specifically, the contact part 24 presses or releases the core 120 of the valve assembly 100 by the vertical movement of the filter element 20. The valve assembly 100 is positioned at an open position by pressing the core 120 by the contact part 24, while the valve assembly 100 is positioned at a closed position by being released from the core 120.

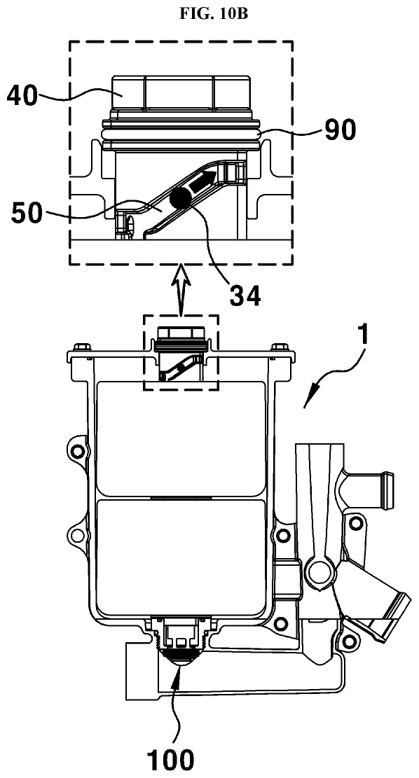

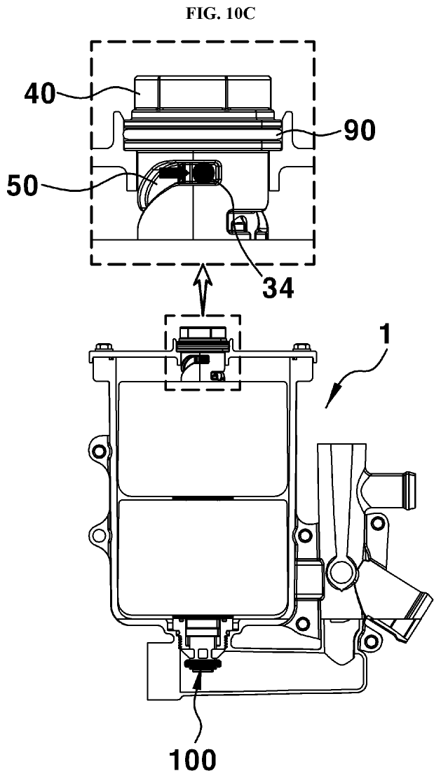

As shown in FIGS. 10A to 10C, an operation of the ion filter 1 according to the present disclosure is as follows.

In FIG. 10A, the protrusion 34 is positioned on the lower flat portion 51 of the guide groove 50, and the valve assembly 100 is positioned at the closed position. Therefore, in this state, the flow from the tubular portion 16 to the inlet 12 of the housing 10 is impossible, and the filter element 20 may be replaced.

In other words, in FIG. 10A, the ion filter 1 is in a replaceable state. Since the valve assembly 100 is in the closed state, no coolant is introduced into the housing 10 through the tubular portion 16. In addition, the gate member 40 is positioned at an uppermost position where the protrusion 34 is positioned on the lower flat portion 51. Therefore, the filter element 20 coupled to the gate member 40 is also in a state of moving up in the housing 10, and the filter element 20 may be replaced by detaching the lid 30.

When the gate member 40 is rotated in the state of FIG. 10A, the protrusion 34 is in a state of moving along the lower inclined portion 57 as shown in FIG. 10B. At this time, the filter element 20 coupled to the gate member 40 gradually moves down in the housing 10. As the valve assembly 100 is gradually opened by the elastic member 130, the coolant may be partially introduced into the housing 10 through the tubular portion 16. At this time, according to the present disclosure, it is possible to implement an air vent function through the intermediate flat portion 53. This will be described below.

When the gate member 40 is continuously rotated in the state of FIG. 10B, the protrusion 34 moves to the upper flat portion 55 through the intermediate flat portion 53 and the upper inclined portion 59 as shown in FIG. 10C. At this time, the rotation of the gate member 40 may not be further rotated by the upper stopper 155. In this state, the valve assembly 100 is completely opened, and the coolant is introduced into the housing 10. In this state, the vehicle is traveling.

As described above, the ion filter 1 according to the present disclosure can achieve the air vent function through the gate member 40 without a separate configuration for the air vent.

In the state as in FIG. 10B, that is, while the protrusion 34 moves from the lower flat portion 51 (the state of FIG. 10A) to the upper flat portion 55 (the state of FIG. 10C), the valve assembly 100 may be ventilated as it is in a partially open state (see FIG. 11). In other words, when the protrusion 34 is positioned on the intermediate flat portion 53, the packing member 90 is also spaced apart from the opening 32, and the valve assembly 100 may be ventilated because it is also in the partially open state.

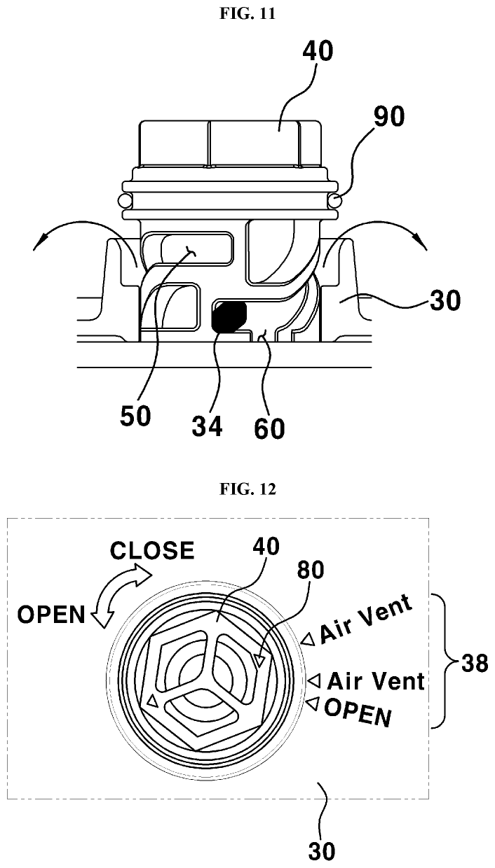

Moreover, the ion filter 1 may include a state display part 38 and a selector 80 so that a state of the ion filter may be easily recognized from the outside. The state of the ion filter 1 may be displayed in various methods through the state display part 38 and the selector 80. As a non-limiting example, referring to FIG. 12, the lid 30 is provided with the state display part 38 indicating open (OPEN), ventilated (AIR VENT), and closed (CLOSE) states. As another non-limiting example, the state display part 38 may also be configured to indicate replacement, operating, and ventilated states of the ion filter 1. Also, the rotated gate member 40 may have the selector 80 capable of displaying each state. The state of the ion filter 1 can be easily recognized from the outside by the state display part 38 indicated by the selector 80. Conventionally, a separate structure for ventilation is included in the ion filter 1. On the contrary, according to the present disclosure, even the ventilation function may be implemented with one gate member 40, thereby simplifying the device.

As described above, the present disclosure provides an ion filter capable of improving maintainability not only in a circular cartridge but also in an atypical cartridge.

What is claimed is:

1. An ion filter comprising:
a housing providing an inlet configured to receive fluid and an outlet configured to discharge the fluid in the housing;
a filter element accommodated in the housing and configured to filter the fluid;
a valve assembly provided at the inlet and configured to selectively allow or block the fluid to be introduced into the housing through the inlet; and
a gate member provided in the housing and configured to control an operation of the valve assembly.

2. The ion filter of claim 1, wherein the gate member is rotatably mounted with respect to the housing, the filter element is coupled to the gate member, and the filter element is configured to, based on a rotation of the gate member, selectively press or release the valve assembly by linearly moving in the housing.

3. The ion filter of claim 2, wherein the gate member includes a socket-shaped connection part, and
wherein the filter element includes a ball-shaped coupling part inserted into and coupled to the socket-shaped connection part.

4. The ion filter of claim 2, wherein the valve assembly includes:
a valve housing coupled to the inlet of the housing, and
a core configured to (i) move in the valve housing by the filter element and (ii) open or close the inlet.

5. The ion filter of claim 4, wherein the valve assembly further includes an elastic member disposed at a circumferential surface of the core, supported by the valve housing, and configured to provide a restoring force to the core.

6. The ion filter of claim 5, wherein the valve assembly further includes:
a plate member coupled to the core and covering the inlet from an outside of the valve assembly, and
a sealing member configured to provide sealing between the plate member and the inlet.

7. The ion filter of claim 2, wherein the housing further includes a lid detachably coupled to the housing and defining an opening in which the gate member is rotatably mounted, and
wherein the lid provides a protrusion at a circumference of the opening to be operatively associated with the gate member.

8. The ion filter of claim 7, wherein the gate member includes a guide groove recessed from a surface of the gate member and configured to move with respect to the protrusion.

9. The ion filter of claim 8, wherein the guide groove further includes:
a lower flat portion positioned on a lower side of the gate member, and
an upper flat portion positioned on an upper side of the gate member, and
wherein the guide groove includes an inclined portion extending obliquely along a circumference of the gate member from the lower flat portion to the upper flat portion.

10. The ion filter of claim 9, wherein the guide groove further includes an intermediate flat portion positioned between the lower flat portion and the upper flat portion.

11. The ion filter of claim 9, further comprising: a separation groove extending from the lower flat portion to a lower end of the gate member.

12. The ion filter of claim 9, wherein the lower flat portion and the upper flat portion are provided with a lower stopper and an upper stopper configured to block movement of the protrusion, respectively.

13. The ion filter of claim 10, further comprising:
a packing member mounted at a circumference of the lid.

14. The ion filter of claim 13, wherein the filter element is configured to, based on the protrusion being positioned on the upper flat portion, (i) press the valve assembly to be in an open position and (ii) move the packing member to contact the opening.

15. The ion filter of claim 13, wherein the filter element is configured to, based on the protrusion being positioned on the lower flat portion, (i) release the valve assembly to be in a closed position and (ii) to move the packing member to be spaced apart from the opening.

16. The ion filter of claim 13, wherein, based on the protrusion being positioned at the intermediate flat portion, the valve assembly is at a partially open position, and the packing member is spaced apart from the opening.

17. The ion filter of claim 10, wherein a position of the valve assembly is determined according to a position of the protrusion with respect to the guide groove.

18. The ion filter of claim 17, wherein an upper surface of the gate member is provided with a selector, and
wherein the lid includes a state display part configured to display a state of the ion filter using a point indicated by the selector.
